(19) United States
(12) Patent Application Publication
(10) Pub. No.: US 2003/0234923 A1
(43) Pub. Date: Dec. 25, 2003

(54) Scanner for optically detecting objects

(75) Inventor: Johann Hipp, Hamburg (DE)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(73) Assignee: IBEO GmbH, Hamburg (DE)

(21) Appl. No.: 10/464,602

(22) Filed: Jun. 18, 2003

(30) Foreign Application Priority Data
Jun. 19, 2002 (DE) 10227299.9

(51) Int. Cl. G01C 1/00; G01B 11/26

(52) U.S. Cl. 356/141.2; 356/141.4

(57) ABSTRACT

A scanner is provided for optically detecting objects. The scanner has a transmitter for generating a light beam and an optical device for fanning out the light beam so as to have a stripe-like cross-section. The fanned-out light beam is rotationally deflected by a rotating, light-deviating element to which the optical device is coupled so as to be in rotational synchronization therewith. A receiver unit is provided to image light spots that are generated when the fanned-out light beam is incident on objects. The receiver unit includes a flat light-receiving sensor having several separate receiving zones, each of which are associated at defined angular positions of the light deviating element to defined length segments of the fanned-out beam's cross-section.

The present invention relates to a scanner defined in the preamble of claim 1.

Scanners of this species are used in particular to measure distances and to detect objects within a monitoring range which for instance extends in front of vehicles.

Scanners of this species comprise a light emitter generating a pulsed, point-like transmitted beam which is rotationally deflected by a rotating light deviating element. Said scanners furthermore comprise a receiving unit which by means of the light deviating element looks in the direction of the transmitted beam and which, when the transmitted beam is incident on an object, will image the generated light spots on a light-sensitive receiving sensor.

Based on the particular angle of transmission and the pulse transit times between transmitter and receiver, the scanners of the above species allow ascertaining one or more distances to objects and the contours of these objects. This design requires a correspondingly programmed analyzer which may be fitted within the scanner or into a separate vehicle computer and may be connected to several vehicle scanners.

One drawback of the above described species' design is that objects may be measured only in one plane.

Accordingly it is the objective of the present invention to create a scanner which is of minimal complexity relative to the state of the art and allows three-dimensional (3D) detection of its environment.

This objective is attained by a scanner exhibiting the features of claim 1.

In the present invention, an optical device is mounted in the path of the transmitted beam and converts the transmitted beam into a cross-sectionally stripe-shaped beam. In this simple manner, when the transmitted beam is oriented so its cross-sectional stripe shall be vertical for instance, objects may be scanned in 3D.

In this respect the present invention provides that the optical device, which illustratively may be a cylindrical lens, shall be coupled in rotationally synchronized manner with the light deviating element that deviates the transmitted beam. Such coupling between the light deviating element and the optical device illustratively may be rigid and assures that the transmitted beam shall preserve constant orientation (relative to the axis of rotation) at the various deviation angles. A transmitted beam of which the stripe-shaped cross-section for instance runs vertically shall retain this vertical orientation while the light deviating element is revolving, and as a result the transmitted beam always is able to sense a constant range of angular height at the different angles of transmission. It is understood with respect to the desired spatial object scanning that the optical device and the light deviating element must be mutually configured in such a way that the transmitted beam's stripe-shaped cross-section shall subtend an angle relative to the plane of pivoting and shall not run parallel to this plane.

Moreover the invention includes a receiving unit imaging the light stripes generated when the transmitted beam is incident on objects—or, as regards objects on which only segments of the transmitted beam are incident, the corresponding light-stripe segments—onto a planar receiving sensor. This receiving sensor comprises several, separately analyzed receiving zones which, for a given angular position of the light deviating element, are each associated with defined length segments of the transmitted beam's stripe-like cross-section.

In the above described design of the scanner of the present invention, the image of the light stripe on the receiving sensor rotates synchronously with the light deviating element.

Conceivably therefore the receiving sensor might be a row of diodes, where this row rotates synchronously with the light deviating element. However such a design is comparatively complex.

Accordingly, in a preferred embodiment of the invention, the receiving sensor shall be mounted irrotationally within the scanner.

In this respect a suitable receiving sensor might be a plurality of detecting diodes of which only a small percentage shall be loaded in the different angular positions of the light deviating element. While such a design solution is theoretically conceivable, it would on the other hand entail high construction costs.

Therefore, in a further preferred embodiment of the present invention, the irrotational receiving sensor comprises receiving zones each associated to a defined angular range of the light deviating element.

In an especially preferred embodiment of the present invention, a first, inner, circular receiving zone is enclosed by at least two external, partially circular receiving zones each subtending an angle of at most 180°. Using a receiving sensor commensurately divided into three receiving zones, the stripe-shaped transmitted beam may be resolved at all deviation angles into three longitudinal zones.

Obviously as well the “concentric ring” enclosing the central receiving zone may comprise more than two receiving zones, for instance comprising four smaller zones each subtending an angular range of 90°. The number of selected zones depends on optimization, namely whether the interference/noise effects that increase with zone size are admissible or whether they must be dealt with by reducing the zone sizes.

Again, the number of the surrounding concentric annular zones consisting of at least two partial zones may easily be increased. In this manner the transmitted beam may be resolved into commensurately more longitudinal segments.

Obviously the present invention is not restricted to flat receiving sensors in the form of concentric rings. Other shapes, for instance polygonal zones etc. also are conceivable.

The receiving system of the invention allows high resolution using a very minimal number of separate receiving zones. In the simplest case, the number of receiving zones corresponds precisely to the number of length segments that resolve the transmitted beam. The scanner of the present invention therefore allows 3D object sensing at a cost of only very minimal construction.

The present invention is elucidated below in relation to drawings.

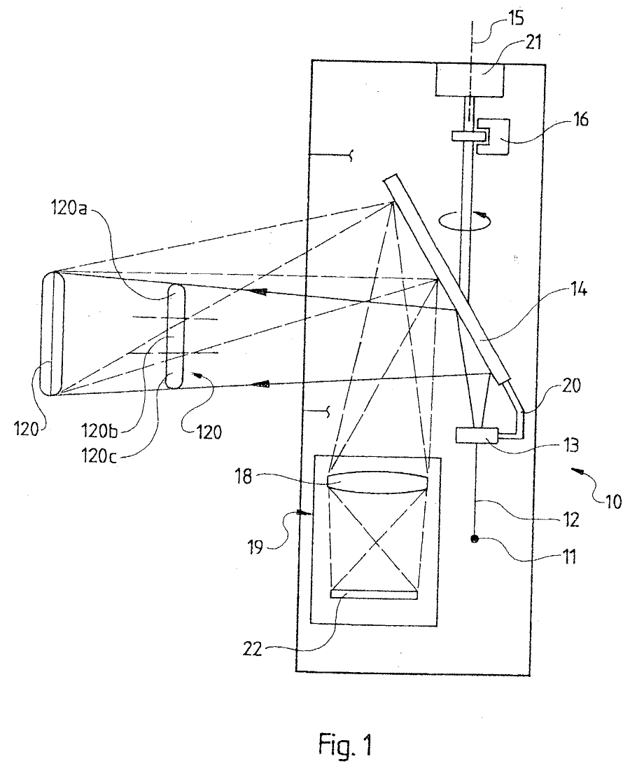

FIG. 1 is a schematic elevation of the significant components of the scanner of the invention, and

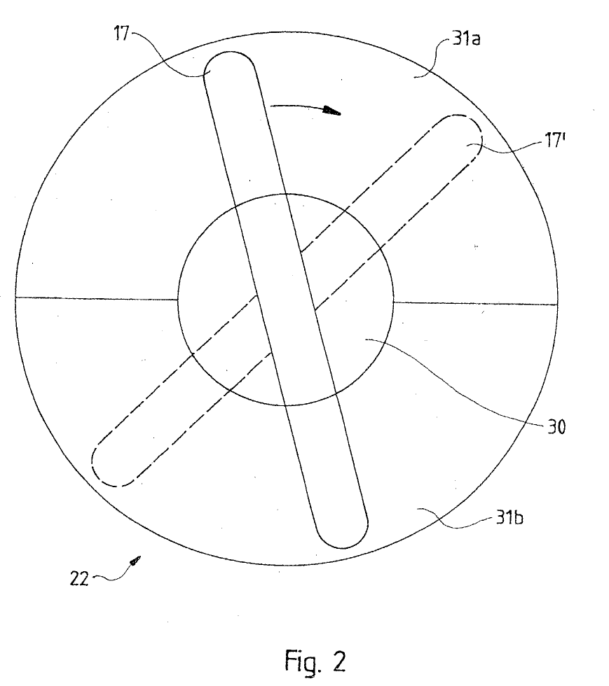

FIG. 2 is a topview of an embodiment mode of a receiving sensor used in the scanner of the invention.

FIG. 1 shows a scanner 10 comprising a transmitter 11 which illustratively is a laser diode. The transmitter 11 generates a pulsed transmitted beam 12. A cylindric lens 13 is configured in the path of the transmitted beam 12 and fans out said beam 12 into a transmitted beam 120 exhibiting a stripe-shaped cross-section. The fanned-out transmitted beam 120 is incident on a rotating mirror 14 which while revolving deflects the transmitted beam 120. The rotating mirror 14 is driven in rotation by a drive 21 about an axis 15, the particular angular positions of the rotating mirror 14 being detected by an angle encoder 16.

The deflected and fanned-out transmitted beam 120 may fall on omitted objects, in which case a stripe-like light spot is generated that will be imaged by a receiver unit 19 looking in the direction of the transmitted beam through a convex lens 18 onto an irrotational, planar, receiving sensor 22.

An essential feature of the shown design is that the cylindrical lens 13 is connected in rotationally synchronized manner by a bracing means 20 to the mirror 14. In this manner the stripe shaped transmitted beam 120 shall retain its alignment during the rotation of the mirror 14.

As already mentioned above, the receiving unit 19 generates as a rule a stripe-like image 17 on the receiving sensor 22, the image 17 rotating jointly with the rotating mirror 14. In order that this stripe-like image 17 may be analyzed in satisfactory manner easily implemented by hardware in all different angular positions of the mirror 14, the invention provides that the receiving sensor 22 exhibit several receiving zones each associated to length segments 120a, 120b, 120c of said stripe-like cross-section of the transmitted beam 120 and to defined angular deviation zones.

In this respect the receiving sensor 22 of FIG. 2 comprises an inner, central, circular receiving zone 30, further two partly annular receiving zones 31a and 31b each subtending an angle of 180° and both jointly enclosing, in the form of a concentric ring, the inner circular segment 30. In the shown embodiment mode, the central, circular segment 30 is configured centrally in the receiving unit 19 and the enclosing ring constituted by the two receiving zones 31a and 31b exhibits a constant radius.

In the shown embodiment, the middle, central receiving zone is associated with the longitudinal range 120b of the transmitted beam 120 across the full deviation range (360°) of the transmitted beam 120. The receiving zones 31a, 31b each are associated alternatingly to the length segments 120a or 120b, a changeover taking place every 180° with respect to the deviation of the transmitted beam 120.

The shown design of the invention is an especially simple assembly which allows resolving the transmitted beams 120 observed by the receiving unit 19 into three length segments at all deviation angles.

A spatial object contour can be generated from the angle encoder data when using the shown scanner of the invention.

1. An optically sensing object scanner, comprising a transmitter transmitting in revolving manner a deviated pulsed transmitted beam by means of a rotating, light-deviating element, further comprising a receiving unit which by means of the light deviating system looks in the direction of the transmitted beam and upon incidence of the transmitted beam on objects will image the light spots entailed thereby onto a light-sensitive receiving sensor,
characterized in that
an optical device (13) is configured in the path of the transmitted beam (12) and fans out the transmitted beam (12) into a transmitted beam exhibiting a stripe-like cross-section (120), the optical device (13) being coupled in rotational synchronization with the light deviating element (14), and in that the receiving unit (19) comprises a flat receiving sensor (22) comprising several separate receiving zones (30, 31a, 31b) each associated at defined angular positions of the light deviating element to defined length segments (120a, 120b, 120c) of the stripe-like transmitted beam's cross-section (120).

2. Scanner as claimed in claim 1, characterized in that the receiving unit (19) is irrotational.

3. Scanner as claimed in claim 2, characterized in that the receiving unit (19) comprises a central, circular receiving zone (30) and at least two annular receiving zones (31a and 31b) each subtending at most an angle of 180° and jointly enclosing the annular receiving zone (30) in the form of a concentric ring of constant width.

4. Scanner as claimed in claim 3, characterized in that the receiving unit (19) comprises further partly annular receiving zones which are configured in the manner of further concentric rings.

5. Scanner as claimed in claim 1, characterized in that the light deviating element is a continuously revolving mirror.

6. Scanner as claimed in claim 1, characterized in that the transmitter is a laser diode.

7. Scanner as claimed in claim 1, characterized in that the optical device (12) is a cylindrical lens.
